(19) United States
(12) Patent Application Publication
(10) Pub. No.: US 2026/0312983 A1
(43) Pub. Date: Oct. 8, 2026

(54) API SECURITY BASED ON INSPECTION OF OBFUSCATED REQUEST AND RESPONSE BODIES

(71) Applicant: Akamai Technologies, Inc., Cambridge, MA (US)

(72) Inventors: Leonid Mirkis, Newton, MA (US); Alex Marks-Bluth, Rehovot (IL)

(73) Assignee: Akamai Technologies, Inc., Cambridge, MA (US)

(21) Appl. No.: 19/386,677

(22) Filed: Nov. 12, 2025

Related U.S. Application Data
(63) Continuation of application No. 18/416,730, filed on Jan. 18, 2024, now abandoned.
(60) Provisional application No. 63/480,460, filed on Jan. 18, 2023.

(51) Int. Cl. H04L 9/40; G06F 9/54

(52) U.S. Cl. CPC H04L 63/1433; G06F 9/547; H04L 63/1425

(57) ABSTRACT

Improved security inspections for API traffic are disclosed. A data obfuscation process is applied to structured data in a request or response body to obfuscate the content while retaining the structural aspects thereof. The resulting sanitized version of the structured data is sent for analysis. For example a machine learning component is trained on such sanitized data to develop a signature or model that detects anomalous interactions with the API. The retained structure contains signals useful for pattern recognition and anomaly detection. The signature or model is preferably developed for a specific API endpoint. Then, a detection engine can be deployed to assess subsequent API traffic for the API endpoint, with such subsequent live traffic being similarly obfuscated by the system before being assessed. The teachings hereof can be used to block attacks or other malicious activities directed against API endpoints.

### BACKGROUND

### Technical Field

This application generally relates to security for online application programming interfaces (APIs).

### Brief Description of the Related Art

It is known in the art to provide an application programming interface (API) as a service on the Internet. An API specification defines how a client may interact with the API, including how to form proper queries and what the responses will contain. Web APIs use hypertext transfer protocol (HTTP) messaging protocol and can be accessed from a wide range of client devices, including desktop computers, laptops, mobile devices, and the like.

Using HTTP, an API request typically has a message header, which contains various field and value pairs (e.g., as defined in the HTTP.x specification), and may also have a message body. The message body is sometimes referred to as the payload. The message body usually contains data that is unstructured or structured. Structured data is data presented in a format that is standardized. Structured data is generally formatted in accord with a content-type such as JSON or XML. Web form data is another example of structured data. The content-type dictates certain syntactical elements and formats that allow the data to be easily read and understood by computers.

It is known in the art to provide security for an API by inspecting the traffic flowing to and from an API endpoint. The API endpoint is typically a hostname, URL path, or IP address, or other network endpoint identifier. Traffic inspection is often performed by an intermediary, such as a proxy server. The intermediary examines the traffic to look for signatures that indicate attacks or other malicious activity, or anomalies that indicate suspicious behavior. Web application firewalls and secure Web gateways perform similar functions, respectively, for application traffic and enterprise traffic that is accessing the public Internet. (More information about web application firewalls can be found in U.S. Pat. No. 8,458,769 (“Cloud Based Firewall System and Service”), the contents of which are hereby incorporated by reference; more information about secure web gateways can be found in U.S. Pat. Nos. 10,834,138, titled “Device Discovery For Cloud-based Network Security Gateways”, and U.S. Pat. No. 11,245,667, titled “Network Security System With Enhanced Traffic Analysis Based On Feedback Loop And Low-risk Domain Identification”, and U.S. Pat. No. 10,9515,89, titled “Proxy Auto-configuration For Directing Client Traffic To A Cloud Proxy”, the contents of both of which are hereby incorporated by reference.)

One challenge with inspecting API traffic is that the request and response bodies frequently contain sensitive information, such as financial data or personally identifiable information (PII) that is subject to privacy regulations. While it is desirable to examine the message bodies to learn the patterns of normal (benign) use of an API as compared to anomalous behavior that may represent a security threat, doing so requires examining, collecting and storing data from the request and response bodies, which may include sensitive information. It is difficult to identify sensitive information in a reliable way so as to avoid processing it.

There are a variety of ways, known in the art by others, to remove or anonymize data. They use hashes, encryption, or the like. Header fields can be encrypted or hashed, for example (sometimes referred to as tokenizing the data). Similarly, the body can be encrypted or hashed. Or, the body can be examined and parsed (e.g., in accord with JSON or XML standards) to find individual name-value pairs (or other data elements), and then sensitive name-value pairs can be encrypted, hashed or removed (e.g., based on a filter match or otherwise) so that such data is not sent in the clear to the analytical system (or removed entirely).

However, the above approaches are lacking. It is difficult to determine which name-value pairs are sensitive because APIs vary widely and change frequently. An enterprise security team may not have a current understanding of the data within a given API in their organization. Also, the above approaches are overbroad: they remove information in such a way that signals useful for security analysis are lost.

The teachings of this patent document addresses the challenges of avoiding or minimizing the processing of sensitive information while still retaining and gaining insight from API traffic for security and attack detection purposes. Improved techniques for inspecting API traffic—disclosed in this document—enable the inspection of request and response bodies and facilitate machine learning and anomaly detection without exposing the system to PII or other types of sensitive information.

The teachings presented herein improve the functioning of a computer system itself. Those skilled in the art will understand these and other improvements from the teachings hereof.

### BRIEF SUMMARY

This section describes some pertinent aspects of this invention. Those aspects are illustrative, not exhaustive, and they are not a definition of the invention. The claims of any issued patent define the scope of protection.

Improved security services and inspections for API traffic are disclosed. A data obfuscation process is applied to obfuscate content in an API request and response bodies (and potentially headers) retaining structural aspects. Preferably the data obfuscation is performed on the content in such a way that obfuscation of an original data value consistently results in the same obfuscated value (except when a salt used in the obfuscation is rotated, as will be described), but the original data value is unrecoverable (e.g., a one way hash). The resulting sanitized version of the API request or response is transmitted to a back-end machine learning component for model training, or used to develop heuristics. Note that API transactions are typically stateful. Hence, the model observes and learns the expected patterns of API traffic in the context of a given session state. A machine learning component is trained, or other analysis performed, on such sanitized data to develop a signature or model that detects anomalous interactions with the API. The signature or model is preferably developed for a specific API endpoint.

Because the system preserves the structure during obfuscation, the location of a piece of content in the structure acts as a key for that content, even if the value of that content itself is obfuscated and unknown. As a result, the system can observe and train models on the pattern of the content across API requests and responses and for a given session state. For example, the system is able to learn whether and when a piece of content changes (as evidenced by the hash or otherwise obfuscated content changing), because it can reliably locate that piece of content in the structure. The system can also learn whether and when other content are consistently presented in relation to that piece of content. Anomalous use of the API can thus be detected, even without knowing what the content actually is.

As a result, API requests and responses can be assessed against the model to detect anomalous behavior and thereby detect malicious or compromised clients, attackers, and the like. The teachings hereof can be used to block attacks or other malicious activities directed against related API endpoints.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a block diagram illustrating a system in accordance with one embodiment of the teachings hereof;

FIG. 2 is a diagram illustrating a process of obfuscating at least some content in API requests and responses, in accordance with one embodiment of the teachings hereof,

FIG. 3 is a diagram illustrating a process of analyzing API traffic for anomalies and mitigating potential threats, while leveraging the data obfuscation of FIG. 2;

FIG. 4 is a diagram illustrating another process of analyzing API traffic for anomalies and mitigating potential threats, while leveraging the data obfuscation of FIG. 2; and,

FIG. 5 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

Basic familiarity with well-known web page, streaming, and networking technologies and terms, such as HTML, URL, XML, AJAX, CSS, GraphQL, HTTP of any version (denoted as HTTP.x), HTTP over QUIC, MQTT, TCP/IP, and UDP, is assumed.

All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software. Hardware may be actual or virtualized.

### INTRODUCTION

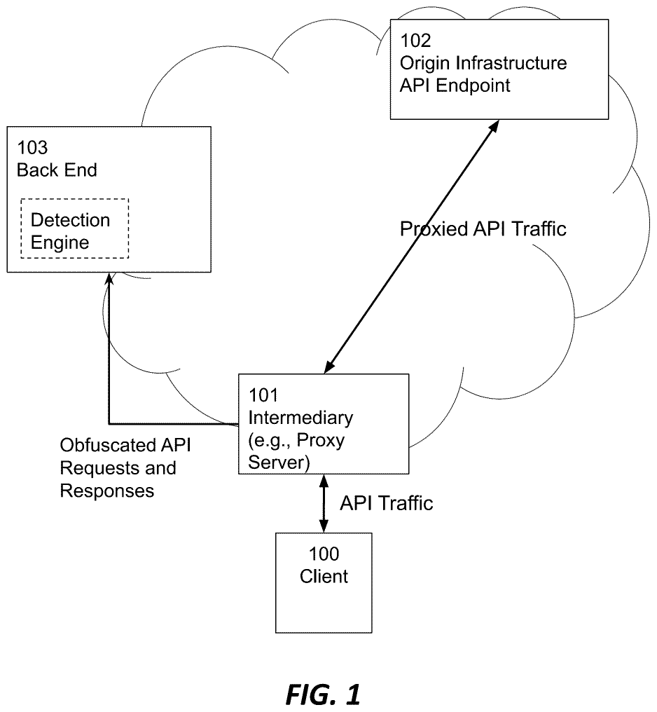

In one embodiment illustrated in FIG. 1, an intermediary (101) sits on a network path between clients (100) and an API endpoint in an origin infrastructure (102). As mentioned, an API endpoint is typically a hostname, or hostname plus URL path, or IP address, that is associated with an API service provided by one or more servers. The intermediary 101 can be implemented as a reverse proxy server. FIG. 1 illustrates one intermediary 101 but typically it would be just one of many intermediaries deployed around the Internet as part of a distributed computing system and/or content delivery network. However this is but one embodiment. The intermediary can be implemented in any suitable appliance, software component, or otherwise.

The intermediary sees API requests sent from the client to the API endpoint as well as the responses sent from the one or more API servers back to the client. The intermediary also sends the API traffic, obfuscated in accord with the teachings hereof, to the back end machines (103) where they are analyzed. The back end machines 103 perform such tasks as model training and development, heuristic development, and can provide a detection engine, which will be described in more detail below.

The obfuscation of the API traffic, which will be described in more detail below, is done in such a way that the structure of request and response bodies are retained, but the content is removed, which reduces privacy and related concerns. The retained structural information is used (at least in part) to conduct the security analysis.

By way of illustration, one of the signals made available to the back end due the retention of the structure is the consistency of a given piece of content, such as a particular name-value pair or a particular value in a name-value pair.

If the vast majority of requests, in a given context of an API workflow (as indicated by its state), present the same piece of content in the same location in the structure of the request body, then the corresponding hashes will be the same (unless the salt changes as described earlier, which can be accounted for). If, in a given API session, the content is different, it may represent an important anomaly that can be detected even from the hashed data.

The same insight applies to responses: the vast majority of responses in a given context of an API workflow, present the same piece of content in the same location in the structure of the request body, then the corresponding hashes will be the same. If, in a given API session, the content is different, it may represent an important anomaly that can be detected even from the hashed data.

The preservation of structure enables the system to consistently find the same piece of content, even without knowing what it actually is. The system learns from the kinds of signals just described, so as to help detect malicious actions.

Turning to implementation examples, in one embodiment, the system applies a security analysis that is based on a machine learning (ML) approach. This means that first there is a training phase in which the API requests and responses associated with a given API endpoint are analyzed by a ML algorithm (e.g., at 103) to create a model that is capable of identifying attributes of “normal” API traffic (“benign”) as compared to anomalous (potentially “malicious”) API traffic. The model is then deployed against online traffic to detect anomalies. This is often referred to as the “detection” phase.

Many ML algorithms are known in the art and the teachings hereof are agnostic to the choice and configuration of them. Any kind of machine learning or model may be complex or as simple as a set of signatures to be applied on an incoming API request, response, or set of requests/responses.

### Request and Response Body Obfuscation

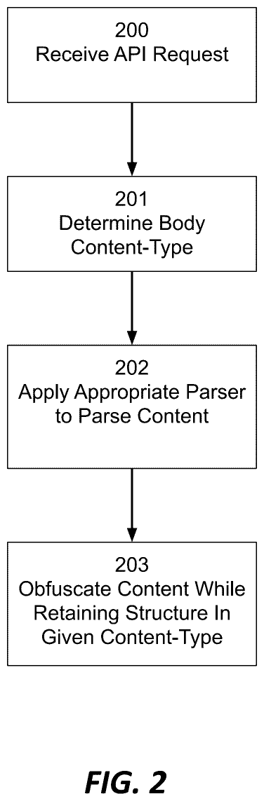

Assume that a portion of an API request body is considered “off-limits” for training, e.g., because the data contained therein is sensitive. Examples include financial data, payment data (e.g., credit card numbers), health and medical data, and all forms of personally identifiable information (PII). (Note that API response bodies can present the same concerns, and the following description about obfuscation applies equally to response bodies, but for brevity of explanation FIG. 2 and the accompanying description uses a request body for illustration.)

Typically, the portion of API requests that are most likely to contain sensitive information are the bodies (or payload). In the HTTP.x protocol, headers and bodies are well defined portions of a message. The bodies can carry structured or unstructured data. Structured data is commonly expressed in accord with a content-type, e.g., a data interchange format such as XML and JSON.

FIG. 2 illustrates a process for obfuscating portions of an API body, in accord with an embodiment of the invention. The FIG. 2 process may be used both for preparing API requests and responses for use offline, as a training set, as well as during a detection phase. Preferably, the FIG. 2 process is conducted in volatile memory with none of the cleartext body being written to disk.

With reference to FIG. 2, at step 200 an API request (or request body) is received. At step 201, the body content-type is determined. Methods for doing this are known in the art by others. This determination can be made by examining the content-type response header from origin, or by attempting to find syntactical structures in the message that match a known content-type.

The determination of body content-type tells the system to use the appropriate lexer and parser for the content-type. The appropriate lexer and parser will understand the delimiters, reserved characters, and other aspects of the content-type, so it will be able to construct a syntactic tree to represent the body. For example, a JSON body would be expected to follow RFC 8259 and ECMA404 standards. The body would likely contain object literals enclosed in curly braces, with a set of properties separated by commas. The properties would contain name/value pairs, with names identified by double-quotes.

At step 202, the body is lexed and parsed according to the identified content-type, producing a tree. As part of this step, the actual content of the body, as distinct from the structure, is identified. For example, the leaf nodes (e.g., a property value in JSON) and the path nodes (e.g., a property name in JSON) in the tree are identified by the parser as content. The structure of the tree itself (minus the node values) is identified as structure rather than content.

At step 203, each piece of content in the tree (nodes) is replaced with obfuscated values. This means that the content of the tree is obfuscated, while the structure of the tree is retained. Obfuscation can be performed in a variety of ways. Preferably the obfuscation is non-reversible and thus anonymizes the content in a way suitable to remove privacy concerns with processing of the resulting obfuscated value. One example is to apply a one-way hash function to each piece of content (each node), and then remove N characters from the beginning and M characters from the end of the resulting string, where N and M are configurable settings. Another example is to apply a one-way hash to each piece of content (each node) with a salt. The salt can be a key retrieved from a key management system such as is described in U.S. Pat. No. 7,600,025, the contents of which are incorporated by reference. It may be necessary to rotate the salt on a periodic basis. To accommodate the difference in salts, the obfuscation routine can return the version of the salt (salt ID) with the obfuscated tree. When comparing obfuscated trees, traffic analysis considers whether the only difference is in hash values at the leaf nodes and the salt ID is different. If so, then the “difference” in hashed values may be because of the rotated salt, and can be considered as not real differences. If the salt ID is the same, then the difference may be taken into account for traffic analysis and related anomaly detection processes.

Another way of obfuscating the data would be to remove every piece of content from the body. Optionally, each piece of removed content can be replaced with a block of placeholder data. In general a given piece of content should be consistently replaced with the same placeholder (except when, e.g., a salt changes as described above). Again, the structure of the body is retained in unmodified form. Note how the process here differs from a process of broadly obfuscating a request body or, e.g., broadly obfuscating JSON name-value pairs, in a way that loses structural information, such as that indicated by the syntactical elements, paths, and data hierarchy.

Traffic Analysis with Obfuscated Bodies for Detecting Security Threats

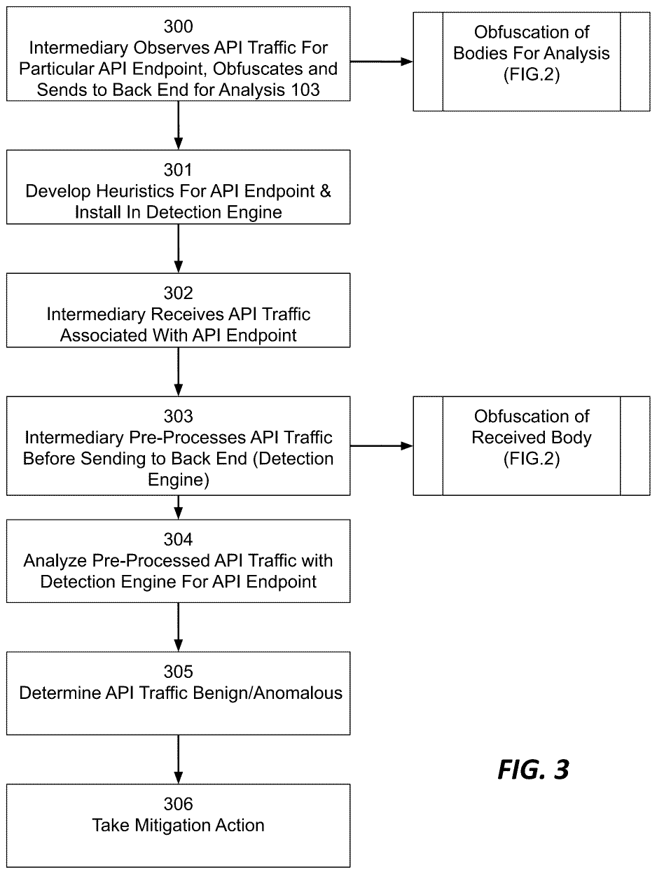

FIG. 3 illustrates an overall process for performing a security analysis on request and response bodies with sensitive content, in accord with one embodiment.

At step 300, an intermediary seeing API traffic for a given API endpoint captures that traffic, obfuscates as described in connection with FIG. 2, and sends it to the back-end machines 103 for analysis, as shown in FIG. 1. As noted earlier, while only one intermediary is shown in FIG. 1, in reality a large platform of intermediaries would likely be sending large volumes of traffic from different clients. The traffic would be sent in such a way that a given user's session with the API (the set of obfuscated requests and responses) would be identified so that the state of the API can be kept and used in the analysis.

At step 301, heuristics are created for a given API endpoint. The heuristics are rules developed from analysis of API requests and responses with bodies that have been obfuscated. The development of heuristics may be accomplished manually by security researchers who analyze the traffic using conventional tools. Both headers and message bodies may be used, though typically only the bodies are obfuscated.

The heuristics are installed in a detection engine that will analyze API traffic for security threats. The detection engine can be run in the back-end machines 103, which are in communication with the intermediary 101.

At step 302, the intermediary receives API traffic flowing to or from the given API endpoint. The API determines that the endpoint is configured for API security inspection by the system described in this document. At 303, the intermediary pre-processes the API request and response bodies by obfuscating in accord with the description above for FIG. 2. The obfuscated traffic is then sent to the detection engine in the back-end 103, as shown at step 304.

At step 304, the detection engine is applied to obfuscated bodies. This occurs in two steps. First, the detection engine examines the obfuscated API traffic to determine whether it contains any differences from what is expected (e.g., from prior traffic and/or a reference that is part of the heuristic). As mentioned earlier, if the only difference is the hash values, and the salt ID is different (has changed), then the differences are ignored. However, if the salt ID is the same, then these are treated as reportable differences. Any differences in structure (not the hash values) is also a reportable difference. Once the reportable differences are identified, the detection engine can apply a classification rule in the heuristic to determine, based on the differences, how to classify the given request or response.

Using the heuristic, the detection engine can analyze the input and produce a label (e.g., benign or anomalous) (step 305). Note that typically a series of requests and responses would be needed as input, i.e., the state of the API is observed. A confidence score can also be produced. The system can be configured such that—if the API traffic is determined to be anomalous and the confidence in that determination is within or above a configurable threshold—then it is flagged for a mitigation action.

In some implementations, upon the detection engine finding a potential security threat, the back-end 103 can send a signal to the intermediary 101 in real-time to take an action against the threat. This may not be possible, however, given the delay in doing so. The findings of the detection engine may be reported for use in future actions. For example, the given client 100 can be identified as malicious (so that it can be blocked in the future), or the relevant API or user can be flagged as compromised.

Preferably the choice mitigation action itself is configurable and the action taken may depend on the confidence level. Examples of mitigation actions include logging the anomaly (including capturing the API traffic and client device information), issuing an alert to a network operations center or API provider, blocking the API traffic, and/or blocking the client. Note that security analysis applies to both inbound and outbound API traffic, so the mitigation action may be designed for example to thwart an attacker (in the inbound case) or to prevent data leakage (in the outbound case).

In FIG. 3, the determined mitigation action is taken in step 306.

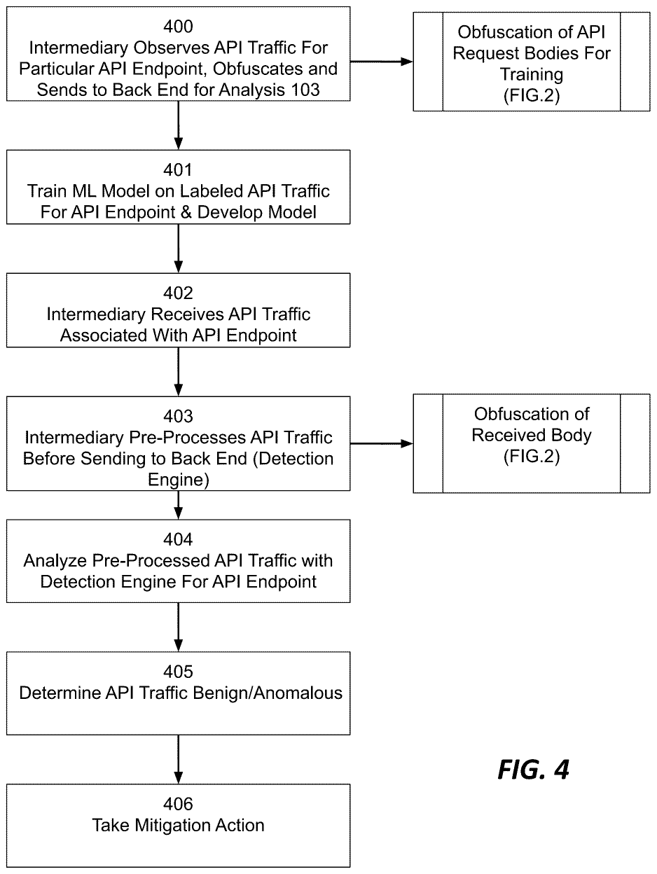

FIG. 4 illustrates an overall process for performing a security analysis on API request and response bodies with sensitive content, in accord with one embodiment. FIG. 4 is similar to FIG. 3 with the difference that use of an ML is illustrated.

At step 400, the ML model is trained on API request and response for a given API endpoint. The training uses request and response bodies that have been obfuscated as described in connection with FIG. 2. The training can involve inputting a set of API traffic into a machine learning algorithm, where the sessions and/or individual requests/responses have been labeled as “benign” or “malicious”. Both headers and message bodies may be used, though typically only the bodies are obfuscated to retain structure as described herein.

In a preferred embodiment, training is conducted on an API endpoint by API endpoint basis. In other words, the training is on labeled clean and malicious traffic that are specific to the API endpoint in question. Hence each API endpoint is associated with a corresponding trained model.

At step 401, the trained model is exported to and installed in a detection engine.

At step 402, the intermediary receives API traffic flowing to or from the given API endpoint. The API determines that the endpoint is configured for security inspection and thus initiates the analysis process.

At 403, the intermediary pre-processes the API request and response bodies by obfuscating in accord with the description above for FIG. 2. The obfuscated traffic is then sent to the detection engine in the back-end 103, as shown at step 404.

At steps 404 and 405, the detection engine is applied to the obfuscated bodies and/or the obfuscated bodies plus the message headers. Using the ML created model (and/or signatures produced thereby), the detection engine can analyze the input and produce a label (e.g., benign or anomalous). A confidence score can also be produced. As before, if the API traffic is determined to be anomalous and the confidence in that determination is within or above a configurable threshold—the detection engine flags the API message for a mitigation action.

In FIG. 4, the determined mitigation action is taken in step 406.

AS noted for FIG. 3 workflow, in some implementations, upon the detection engine finding a potential security threat, the back-end 103 can send a signal to the intermediary 101 in real-time to take an action against the threat. This may not be possible, however, given the delay in doing so. The findings of the detection engine may be reported for use in future actions. For example, the given client 100 can be identified as malicious (so that it can be blocked in the future), or the relevant API or user can be flagged as compromised.

Note that in both FIGS. 3 and 4, the detection engine was described as being executed in the back-end 103. However, it is also possible that the detection routine can be run locally in the intermediaries 101. So, for example, a ruleset or trained model could be deployed to an intermediary. However, the intermediary would typically need to keep the state of API sessions, observe request and response series, and execute the ruleset/model. This would incur a relatively heavy processing and resource load on an intermediary.

### Example: Obfuscation in Body Containing JSON

Below is an example of the effect of the data obfuscation process that was described in connection with FIG. 2. In this example, a JSON formatted object from a body is obfuscated. The original body is transformed into a tree of hashed values to represent traversals.

TABLE A
JSON

```
Original Body
{
  “order”: {
    “description”: “Sea Shells”,
    “orderno”: 12345678,
    “deliverytype”:
{ “days”: 3,
          “transport”: “truck” }
  }
}
Obfuscated Body
{
  “56757567657”: {
    “566598356787”: “36561205368656C6C7”,
    “346577653”: “36678912368656B6B5”,
    “3569759864”:
{ “4765676”: “40912121368656B6C1”,
          “345678568”: “45678121368656A6A1” }
  }
}
```

### Example: Obfuscation in Body Containing XML

Another example of the effect of the data obfuscation process that was described in connection with FIG. 2 comprises obfuscation of an XML formatted object. This can involve obfuscation of XML-formatted bodies, e.g., identifying CDATA content of XML elements or values of XML attributes, and replacing them with hashed values.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus-such as a microprocessor in a computer, digital data processing device, or other computing apparatus-as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

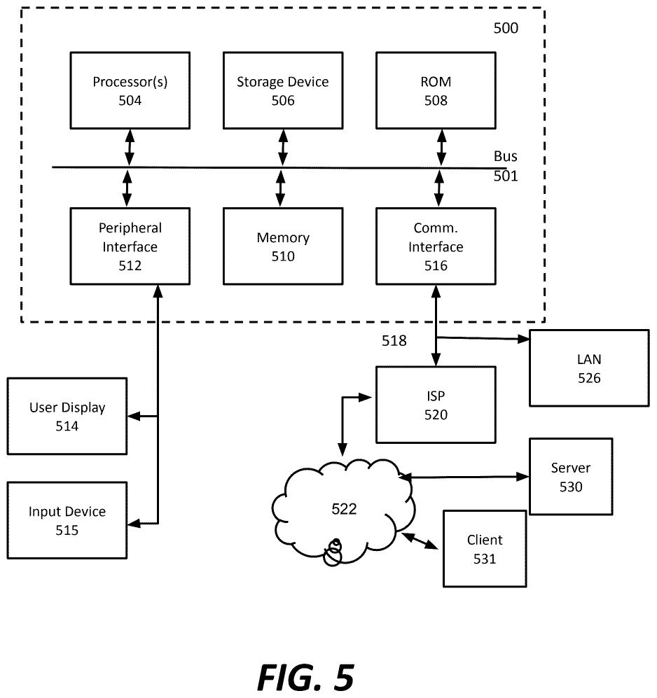

FIG. 5 is a block diagram that illustrates hardware in a computer system 500 upon which such software may run in order to implement embodiments of the invention. The computer system 500 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 500 includes a microprocessor 504 coupled to bus 501. In some systems, multiple processor and/or processor cores may be employed. Computer system 500 further includes a main memory 510, such as a random access memory (RAM) or other storage device, coupled to the bus 501 for storing information and instructions to be executed by processor 504. A read only memory (ROM) 508 is coupled to the bus 501 for storing information and instructions for processor 504. A non-volatile storage device 506, such as a magnetic disk, solid state memory (e.g., flash memory), or optical disk, is provided and coupled to bus 501 for storing information and instructions. Other application-specific integrated circuits (ASICs), field programmable gate arrays (FPGAs) or circuitry may be included in the computer system 500 to perform functions described herein.

A peripheral interface 512 may be provided to communicatively couple computer system 500 to a user display 514 that displays the output of software executing on the computer system, and an input device 515 (e.g., a keyboard, mouse, trackpad, touchscreen) that communicates user input and instructions to the computer system 500. However, in many embodiments, a computer system 500 may not have a user interface beyond a network port, e.g., in the case of a server in a rack. The peripheral interface 512 may include interface circuitry, control and/or level-shifting logic for local buses such as RS-485, Universal Serial Bus (USB), IEEE 1394, or other communication links.

Computer system 500 is coupled to a communication interface 516 that provides a link (e.g., at a physical layer, data link layer,) between the system bus 501 and an external communication link. The communication interface 516 provides a network link 518. The communication interface 516 may represent an Ethernet or other network interface card (NIC), a wireless interface, modem, an optical interface, or other kind of input/output interface.

Network link 518 provides data communication through one or more networks to other devices. Such devices include other computer systems that are part of a local area network (LAN) 526. Furthermore, the network link 518 provides a link, via an internet service provider (ISP) 520, to the Internet 522. In turn, the Internet 522 may provide a link to other computing systems such as a remote server 530 and/or a remote client 531. Network link 518 and such networks may transmit data using packet-switched, circuit-switched, or other data-transmission approaches.

In operation, the computer system 500 may implement the functionality described herein as a result of the processor executing code. Such code may be read from or stored on a non-transitory computer-readable medium, such as memory 510, ROM 508, or storage device 506. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 518 (e.g., following storage in an interface buffer, local memory, or other circuitry).

It should be understood that the foregoing has presented certain embodiments of the invention but they should not be construed as limiting. For example, certain language, content-types, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1.-15. (canceled)

16. A method to provide an API security service, the method comprising:
capturing API traffic between a client and an API endpoint, the API traffic including at least one of a request and a response that contains structured data;
modifying the structured data in the API traffic, at least by:
(i) identifying a content-type associated with a structure of the structured data, and
(ii) based on the content-type, obfuscating content of the structured data while retaining the structure of the structured data wherein said obfuscating comprises consistently replacing a particular piece of content with a particular obfuscated value across a set of API traffic, the set of API traffic comprising at least one of: a plurality of requests and a plurality of responses;
passing at least the modified structured data in the API traffic to a detection engine that uses the modified structured data to assess the API traffic for security risk, at least by identifying a change in an obfuscated piece of content across the set of API traffic; and,
based on a response from the detection engine, identifying a security risk level associated with the API traffic.

17. The method of claim 16, wherein the API endpoint comprises any of a hostname, a URL, an IP address.

18. The method of claim 16, wherein the API traffic comprises one or more headers and a body, the body containing the structured data.

19. The method of claim 16, wherein the structured data comprises content in any of JSON and XML format.

20. The method of claim 16, wherein the structured data comprises content in a JSON format, and said obfuscating comprises: obfuscating at least property names and property values.

21. The method of claim 16, wherein the structured data comprises data in XML format, and obfuscating content of the structured data comprises obfuscating at least CDATA of XML elements and values of XML attributes.

22. The method of claim 29, wherein said obfuscating comprises at least one of: (i) applying a hash function to the content, and (ii) replacing the content with predetermined placeholder data.

23. The method of claim 16, further comprising: where a security risk level exceeds a configured threshold, taking an action with respect to any of the API traffic and the client, the action comprising any of alert, block, log.

24. The method of claim 16, wherein said obfuscating is performed by a proxy server.

25. The method of claim 16, wherein the retained comprises syntactical elements of a content-type.

26. The method of claim 16, wherein the detection engine uses a location of an obfuscated piece of content in the structure as a key for identifying such piece of content for security analysis.

27. A system comprising one or more servers having circuitry forming one or more processors and memory holding computer program instructions to be executed on the one or more processors, the computer program instructions when so executed causing the one or more servers to:
capture API traffic between a client and an API endpoint, the API traffic including at least one of a request and a response that contains structured data;
modify the structured data in the API traffic, at least by:
(i) identifying a content-type associated with a structure of the structured data, and
(ii) based on the content-type, obfuscating content of the structured data while retaining the structure of the structured data wherein said obfuscating comprises consistently replacing a particular piece of content with a particular obfuscated value across a set of API traffic, the set of API traffic comprising at least one of: a plurality of requests and a plurality of responses;
pass at least the modified structured data in the API traffic to a detection engine that uses the modified structured data to assess the API traffic for security risk, at least by identifying a change in an obfuscated piece of content across the set of API traffic; and,
based on a response from the detection engine, identify a security risk level associated with the API traffic.

28. A non-transitory computer readable medium holding computer program instructions for execution by one or more computers, the computer program instructions when so executed causing the one or more computers to:
capture API traffic between a client and an API endpoint, the API traffic including at least one of a request and a response that contains structured data;
modify the structured data of the API traffic, at least by:
(i) identifying a content-type associated with a structure of the structured data, and
(ii) based on the content-type, obfuscating content of the structured data while retaining the structure of the structured data wherein said obfuscating comprises consistently replacing a particular piece of content with a particular obfuscated value across a set of API traffic, the set of API traffic comprising at least one of: a plurality of requests and a plurality of responses;
pass at least the modified structured data in the API traffic to a detection engine that uses the modified structured data to assess the API traffic for security risk, at least by identifying a change in an obfuscated piece of content across the set of API traffic; and,
based on a response from the detection engine, identify a security risk level associated with the API traffic.

29. The method of claim 16, wherein the retaining of the structure of the structured data being is performed consistently across the set of API traffic.

30. The method of claim 29, wherein the set of API traffic is defined by a lifetime of a salt value incorporated into a hash function that is applied to perform said obfuscating.
